(19) United States
(12) Patent Application Publication
(10) Pub. No.: US 2014/0116350 A1
(43) Pub. Date: May 1, 2014

(54) ANIMAL GROOMING BRUSH

(71) Applicant: Duncan Russell Simmons, Weatherby Lake, MO (US)

(72) Inventor: Duncan Russell Simmons, Weatherby Lake, MO (US)

(21) Appl. No.: 14/058,940

(22) Filed: Oct. 21, 2013

Related U.S. Application Data
(60) Provisional application No. 61/719,512, filed on Oct. 29, 2012.

(51) Int. Cl. A01K 13/00

(52) U.S. Cl. CPC A01K 13/001
USPC 119/600

(57) ABSTRACT

An animal grooming brush may include a first segment arm and a second segment arm both having a proximal end and a distal end. The proximal ends may attach. The distal ends of the first segment arm and the second segment arm may have a receiving component. A first brush head and a second brush head may have an operating side and a non operating side, and may include an engaging component. The engaging component of the first brush head may be removably attached to the receiving component of the first segment arm, and the second brush head may be removably attached to the receiving component of the second segment arm. The operating side of the first brush head may face the operating side of the second brush head. The first brush head and second brush head may be reeplaced with different types of bristle heads.

### CROSS-REFERENCE TO RELATED APPLICATION

This application claims the benefit of U.S. provisional application number 61/719,512, filed Oct. 29, 2012, the contents of which are herein incorporated by reference.

### BACKGROUND OF THE INVENTION

The present invention relates to animal grooming brushes, and more particularly, to an animal grooming brush having two adducting heads.

Regular grooming provides many benefits for a variety of animal species. Grooming can be difficult, however, where the animal is not cooperative, or the grooming tools are not efficient. Currently, single head brushes typically reach the animal's coat only on the surface, and do not reach the undercoat. When used vigorously, a brush may reach the undercoat, but is an uncomfortable process for the animal and causes stress. The abrasion is amplified because the bristles in a large brush are limited in their angle of functionality. Currently, brushes do not mimic the natural motion of the animal's own grooming techniques, and can damage the eyes when working in that area.

As can be seen, there is a need for an animal grooming brush that may be comfortable and calming for the animal, mimics the animal's own grooming technique and avoids the risk of scratching sensitive areas on the body of the animal.

### SUMMARY OF THE INVENTION

In one aspect of the present invention, an animal grooming brush comprises: a handle comprising a first segment arm and a second segment arm, wherein the first segment arm and the second segment arm each have a proximal end and a distal end, wherein the proximal end of the first segment arm connects to the proximal end of the second segment arm, wherein the distal end of the first segment arm and the distal end of the second segment arm comprise a receiving component; and a first brush head and a second brush head having an operating side and a non operating side, wherein the first brush head and the second brush head comprise an engaging component, wherein the engaging component of the first brush head removably attaches to the receiving component of the first segment arm, and the engaging component of the second brush head removably attaches to the receiving component of the second segment arm, wherein the operating side of the first brush head faces the operating side of the second brush head.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention in use;

FIG. 2 is a perspective view of an exemplary embodiment of the present invention in an open position;

FIG. 3 is a perspective view of an exemplary embodiment of the present invention in a closed position;

FIG. 4 is a perspective detail view of an exemplary embodiment of the present invention;

FIG. 5 is an exploded detail view of an exemplary embodiment of the present invention demonstrating removal of an exemplary attachment;

FIG. 6 is an exploded detail view of an exemplary embodiment of the present invention demonstrating application of an alternate exemplary attachment;

FIG. 7 is a perspective detail view of an exemplary embodiment of the present invention;

FIG. 8 is a section detail view of an exemplary embodiment of the present invention along line 8-8 in FIG. 4;

FIG. 9 is a perspective view of an alternate embodiment of the present invention;

FIG. 10 is a perspective view of an alternate embodiment of the present invention; and

FIG. 11 is a perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an animal grooming brush that may include a first segment arm and a second segment arm both having a proximal end and a distal end. The proximal ends may attach. The distal ends of the first segment arm and the second segment arm may have a receiving component. A first brush head and a second brush head may have an operating side and a non operating side, and may include an engaging component. The engaging component of the first brush head may be removably attached to the receiving component of the first segment arm, and the second brush head may be removably attached to the receiving component of the second segment arm. The operating side of the first brush head may face the operating side of the second brush head. The first brush head and second brush head may be replaced with different types of bristle heads.

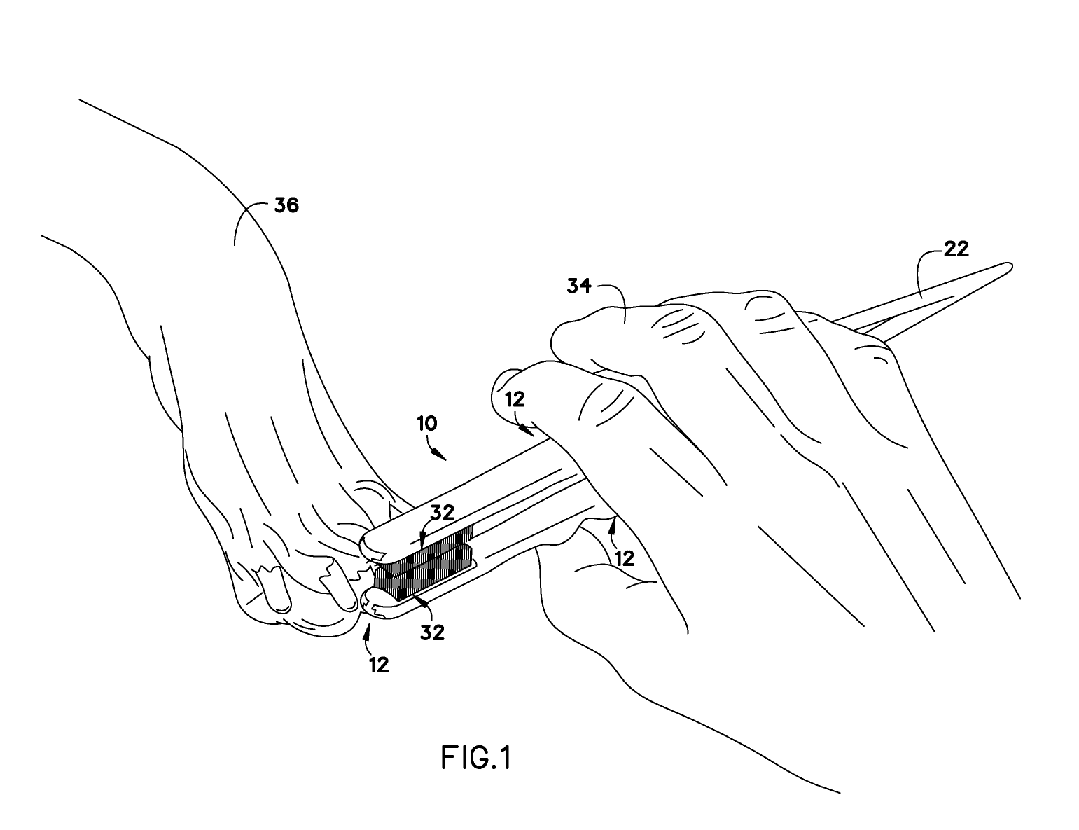

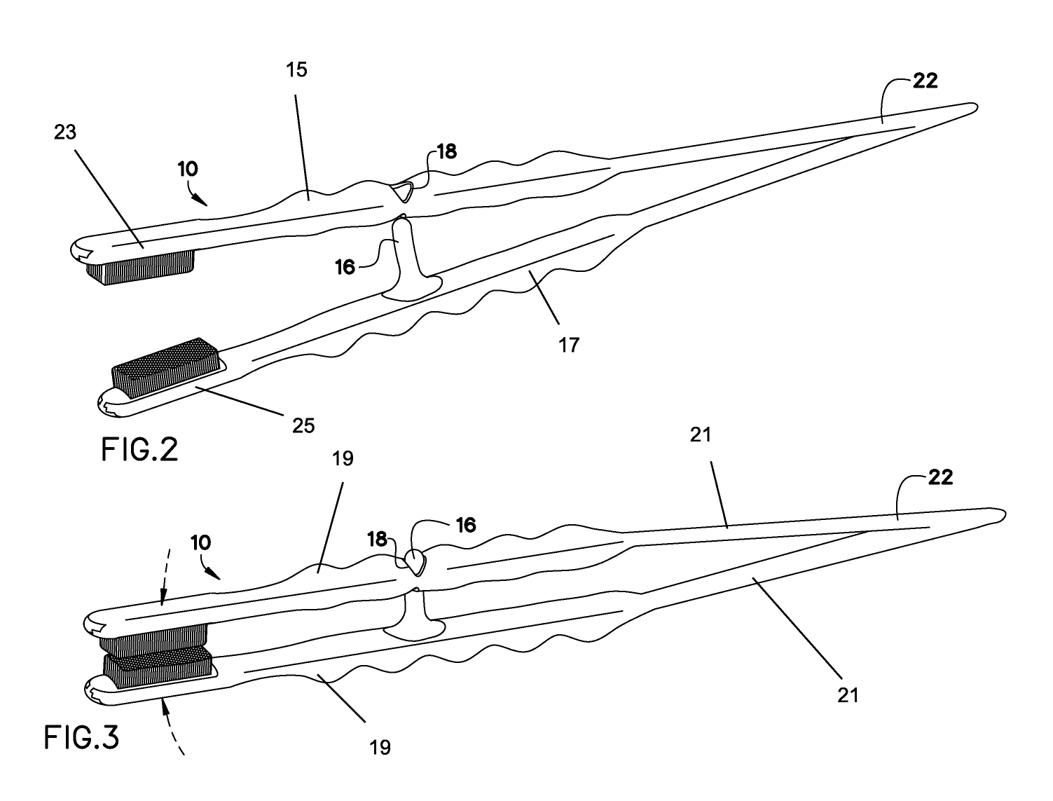

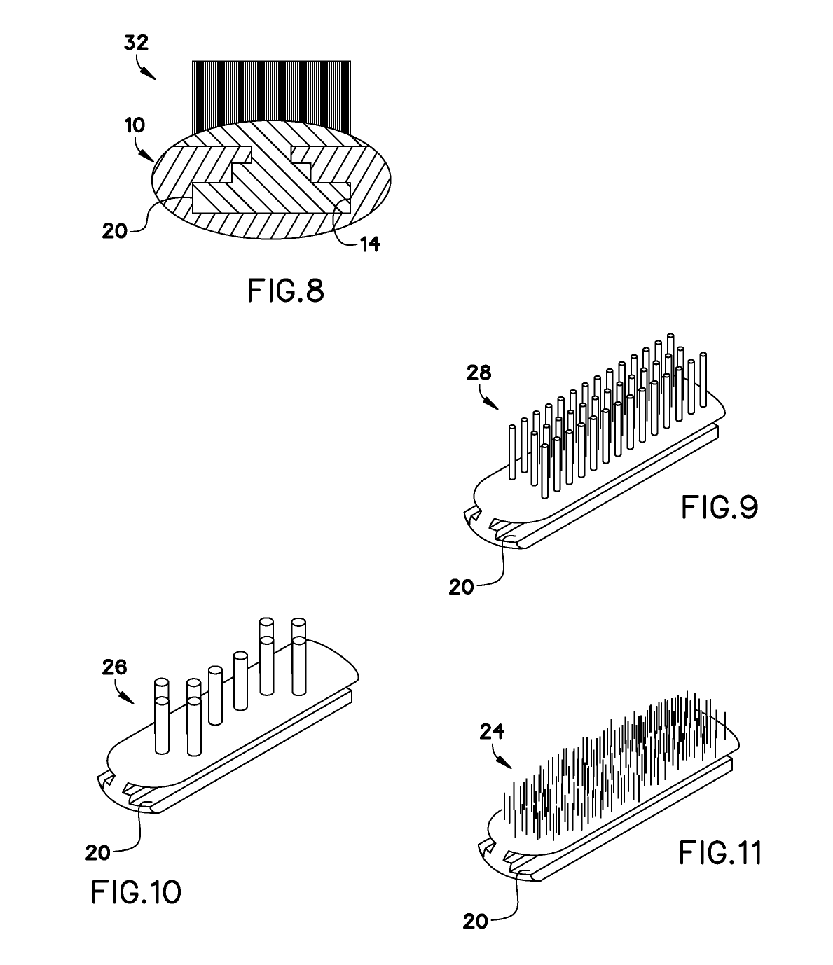

As is illustrated in FIGS. 1 through 11, an animal grooming brush may include a handle 10. The handle 10 may include a first segment arm 15 and a second segment arm 17. The first segment arm 15 and the second segment arm 17 each may have a proximal end 21 and a distal end 19. The proximal end 21 of the first segment arm 15 may attach to the proximal end 21 of the second segment arm 17. In certain embodiments, a spring neck 22 may be in place between the proximal end 21 of the first segment arm 15 and the proximal end 21 of the second segment arm 17. In certain embodiments along the first segment arm 15 and along the second segment arm 17 may be a grip region 12. The grip region 12 may be shaped so that it is ergonomically proper for use by an individual operator 34 on a particular animal 36. The grip region 12 may include a plurality of finger grooves spaced apart so that the fingers of the operator 34 may be in a comfortable griping position. The distal end 19 of the first segment arm 15 and the distal end 19 of the second segment arm 17 may include a receiving component 14. In certain embodiments the receiving component 14 may be a channel section. In certain embodiments, the receiving component 14 may be a double-T slot or some other receiving shape.

In certain embodiment, the first segment arm 15 may include an indicator hole 18. The indicator hole 18 may receive an indicator post 16 that may be attached to the second segment arm 17. The indicator post 16 may have a head shape that may enter the indicator hole 18, but not go all the way through the indicator hole 18, thus locking the minimum angle that the device may close. This The indicator hole 18 and indicator post 16 may allow for the possibility of the operator 34 to use a pinching motion with the animal grooming brush without actually scratching any sensitive area of the animal 36 or pinching the operator 34 himself/herself with the animal grooming brush. The pinching motion may mimic the animal's own grooming techniques which may help to calm the animal 36 during the grooming process.

In certain embodiments, a first brush head 23 and a second brush head 25 may include an engaging component 20. The engaging component 20 of the first brush head 23 may removably attach to the receiving component 14 of the first segment arm 15. The engaging component 20 of the second brush head 25 may removably attach to the receiving component 14 of the second segment arm 17. In certain embodiments the engaging component 20 may be a rail section. In certain embodiments the engaging component 20 may be a double-T rail or some other engaging shape. The first brush head 23 and the second brush head 25 may have a plurality of bristles. The plurality of bristles of the first brush head 23 face the plurality of bristles of the second brush.

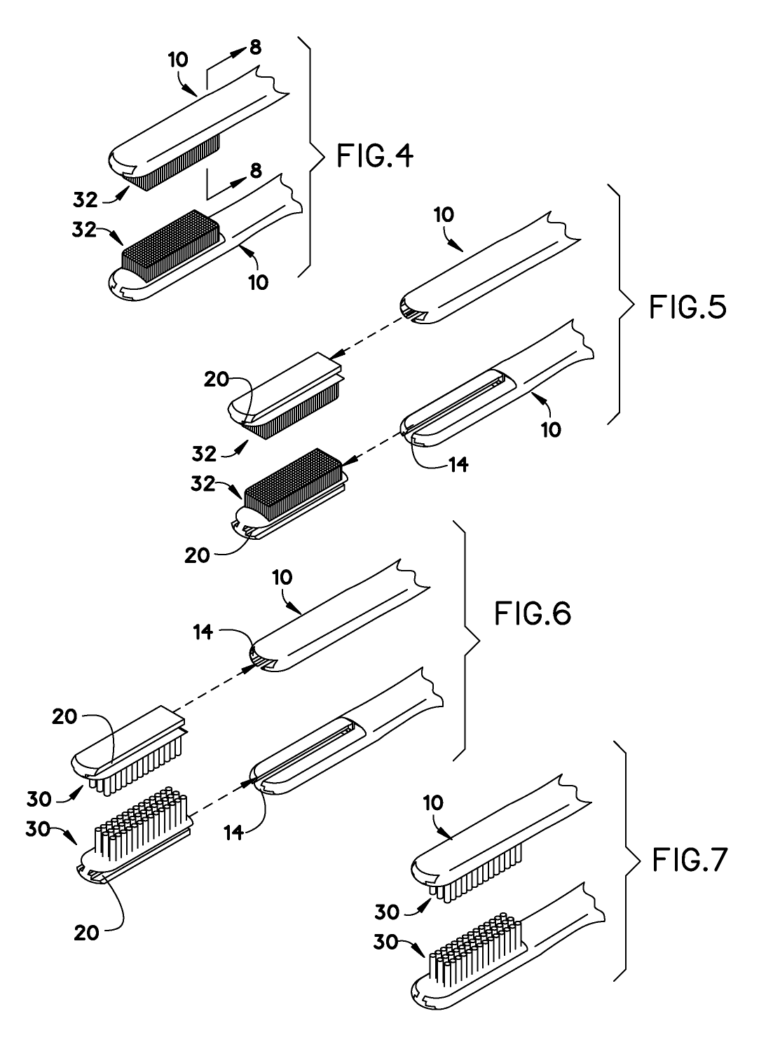

In certain embodiments, the animal grooming brush may include several different types of first brush heads 23 and second brush heads 25. Depending on the type of brush required for the type of work, the specific brush for the specific work may be removably attached to the first segment arm 15 and the second segment arm 17 as is shown in FIGS. 4 through 6. The first brush head 23 and the second brush head 25 may include a plurality of pin brush head bristles 24, a plurality of flea comb bristles 26, a plurality of straight stiff head bristles 28, a plurality of bath-head bristles 30, a plurality of increasing density bristles 32 or the like. The bath-head bristles 30 may be made out of rubber or the like for cleaning around the eyes, ears and the behind of the animal 36. The increasing density bristles 32 may be used to customize for different density coats of animals 36. The straight stiff head bristles 28 may be used for the matt of the animal 36 in order to clean out leaves, twigs, bugs and general brushing. The pin brush head bristles 24 may be used for softer coats and final grooming as for showing of the animal 36.

It should be understood, of course, that the foregoing relates to exemplary embodiments of the invention and that modifications may be made without departing from the spirit and scope of the invention as set forth in the following claims.

What is claimed is:

1. An animal grooming brush comprising:
a handle comprising a first segment arm and a second segment arm, wherein the first segment arm and the second segment arm each have a proximal end and a distal end, wherein the proximal end of the first segment arm connects to the proximal end of the second segment arm; and
a first brush head and a second brush head having a plurality of bristles, wherein the plurality of bristles of the first brush head face the plurality of bristles of the second brush head.

2. The animal grooming brush of claim 1, wherein the distal end of the first segment arm and the distal end of the second segment arm comprise a receiving component.

3. The animal grooming brush of claim 1, wherein the first brush head and the second brush head further comprise an engaging component.

4. The animal grooming brush of claim 1, further comprising a grip region along the first segment arm and the second segment arm, wherein the grip region comprises a plurality of finger grooves.

5. The animal grooming brush of claim 1, further comprising a spring neck attached to the proximal end of the first segment arm and the proximal end of the second segment arm.

6. The animal grooming brush of claim 1, further comprising an indicator hole along the first segment arm of the handle.

7. The animal grooming brush of claim 4, further comprising an indicator post having a head along the second segment arm of the handle, wherein the indicator post removably engages with the indicator hole along the first segment, wherein the indicator post head enters the indicator hole, but does not exit the indicator hole completely.

8. The animal grooming brush of claim 2, wherein the receiving component comprises a channel section.

9. The animal grooming brush of claim 8, wherein the receiving component comprises a double-T slot.

10. The animal grooming brush of claim 3, wherein the engaging component comprises a rail section.

11. The animal grooming brush of claim 10, wherein the engaging component comprises a double-T rail.

12. The animal grooming brush of claim 1, wherein the first brush head and second brush head bristles comprises a plurality of pin brush head bristles.

13. The animal grooming brush of claim 1, wherein the first brush head and second brush head bristles comprises a plurality of flea comb bristles.

14. The animal grooming brush of claim 1, wherein the first brush head and second brush head bristles comprises a plurality of straight stiff head bristles.

15. The animal grooming brush of claim 1, wherein the first brush head and second brush head bristles comprises a plurality of bath-head bristles.

16. The animal grooming brush of claim 1, wherein the first brush head and second brush head bristles comprises a plurality of increasing density bristles.
